(19) United States
(12) Patent Application Publication
(10) Pub. No.: US 2015/0182882 A1
(43) Pub. Date: Jul. 2, 2015

(54) SEPARATION PROCESS

(71) Applicant: ICM, INC., Colwich, KS (US)

(72) Inventors: Charles C. Gallop, Gower, MO (US); Jeremy Edward Javers, St. Joseph, MO (US); Christopher Riley William Gerken, Helena, MO (US); Samuel Vander Griend, Wichita, KS (US)

(21) Appl. No.: 14/586,328

(22) Filed: Dec. 30, 2014

Related U.S. Application Data
(60) Provisional application No. 61/922,201, filed on Dec. 31, 2013.

(51) Int. Cl. B01D 21/01

(52) U.S. Cl. CPC B01D 21/01

(57) ABSTRACT

This disclosure describes providing techniques to separate suspended solids from liquid with dissolved solids in a process stream. This disclosure describes a method for adding a chemical to the process stream in which the chemical induces flocculation to occur with suspended solids. The process separates the suspended solids formed in in flocs by using a dewatering device. This creates a liquid with dissolved solids stream and suspended solids for furthering processing.

### CROSS-REFERENCE TO RELATED APPLICATION

This application claims the benefit of priority to U.S. Provisional Application No. 61/922,201, entitled “Separation Process,” filed on Dec. 31, 2013, the content of which is hereby incorporated by reference in its entirety.

### TECHNICAL FIELD

The subject matter of this disclosure relates to methods of separating suspended solids from liquid containing dissolved solids in process streams in a production facility. In particular, the subject matter is directed to adding a chemical to a process stream that is used in combination with a device to enhance solid-liquid separation, to filter the suspended solids from the liquid containing dissolved solids, to recover components, to reduce energy needed for processing the process streams downstream, and to increase overall efficiency of a process.

### BACKGROUND

The United States relies on imported petroleum to meet the needs of transportation fuel. To reduce dependence on the imported petroleum, the Environmental Protection Agency (EPA) set standards for a Renewable Fuel Standard (RFS2) program each year. The RFS2 includes a mandate to blend renewable fuels into transportation fuel, which ensures the continued growth of renewable fuels. The RFS2 proposes annual standards for cellulosic biofuel, biomass-based diesel, advanced biofuel, and total renewable fuel that apply to gasoline and diesel. The proposal for 2014 is 17 million gallons of cellulosic biofuels, 1.28 billion gallons of biomass-based diesel, 2.0-2.5 billion gallons of advanced biofuel, and 15-15.5 billion gallons of renewable fuel to be produced and for consumption. (http://www.epa.gov/otaq/fuels/renewablefuels/documents/420f13048.pdf).

As a result of the RFS2, facilities are evaluating new technologies to produce cellulosic biofuels from a variety of feedstocks. One cellulosic biofuel is cellulosic ethanol produced by converting sugars from cellulose feedstock into cellulosic ethanol.

In order to produce the cellulosic ethanol, the process separates solids from liquids in process streams. This separation has been performed with a separation device to be discussed below. After separation, the process sends the unconverted solids to be dried in dryers. However, a problem may occur when drying the unconverted solids. There may be more liquids present in the unconverted solids than desired, so the downstream process requires a large amount of energy to dry the unconverted solids and increases operating costs. Furthermore, the process sends the liquids to fermentation, but there may be more solids in the liquids than desired. This may create problems with the process with respect to yeast recycle and co-product composition. Previous attempts with separation devices for solids-liquids separation tend to drive up capital and/or operating costs and present maintenance issues.

In an example for producing cellulosic ethanol, the process may use a Rotary Vacuum-Drum Filter (RVDF) as the separating device to separate the solids from the liquids. The RVDF has a drum, which rotates in a tub of liquid and the drum may be pre-coated with diatomaceous earth to be used as a filtering aid. The RVDF removes a high portion of solids with use of a vacuum that draws the liquids and the solids onto the drum pre-coat surface. The RVDF further filters the liquids through a filter media to the internal of the drum. However, there are disadvantages associated with the RVDF, which includes large capital costs, requiring a large amount of space, requiring expensive filter aid material such as diatomaceous earth, and spending large amounts of operating costs due to a vacuum system and high electrical horsepower usage.

Accordingly, there is a need for improved methods for separating the solids from the liquids in process streams in a more efficient manner without increasing the capital costs, operating costs, or amount of energy for downstream processing.

### SUMMARY

This disclosure describes a process using a chemical and a device to separate the solids from the liquids in process streams; to recover components; and to improve overall efficiency in a production facility. The process reduces capital costs, reduces operating costs, and reduces an amount of energy used for downstream processing in the production facility.

In an embodiment, a process adds an effective amount of a chemical to a process stream to induce flocculations of suspended solids, separates the suspended solids from the process stream by using a device, and creates (1) a first liquid with dissolved solids stream and (2) a first suspended solids stream. The process further treats the first liquid with dissolved solids stream to remove residuals by using a treatment process; and creates (3) a second liquid with dissolved solids stream and (4) a second suspended solids stream.

In another embodiment, a process adds an effective amount of a chemical to a process stream combined with a liquid filtrate to cause two or more particles to aggregate to form flocculations of suspended solids, separates the suspended solids from a combination of the chemical, the process stream, and the liquid filtrate by using a dewatering device; and creates (1) a liquid with dissolved solids stream and (2) a suspended solids stream.

In yet another embodiment, a process adds an effective amount of a polyacrylamide or its derivatives to a process stream to induce flocculations of suspended solids, mixes the chemical with the process stream for a predetermined amount of time, separates the flocculations of suspended solids from the process stream by using a device; and creates a liquid with dissolved solids stream and a suspended solids stream.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other aspects and advantages of the claimed subject matter will be apparent from the following Detailed Description of the embodiments and the accompanying figures.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. The features illustrated in the figures are not necessarily drawn to scale, and features of one embodiment may be employed with other embodiments as the skilled artisan would recognize, even if not explicitly stated herein.

FIG. 1 illustrates an example process for a separation process located in a front end of a production facility.

FIG. 2 illustrates an example embodiment of a separation process with a device.

FIG. 3 illustrates an example embodiment of a separation process with two devices.

FIG. 4 illustrates another example embodiment of a separation process with a device and a treatment process.

FIG. 5 illustrates another example embodiment of a separation process with two different types of devices and a treatment process.

FIG. 6 illustrates another example process for a separation process located in a front end of the production facility.

FIG. 7 illustrates yet another example process for a separation process located in a front end of the production facility.

FIG. 8 illustrates yet another example process for a separation process located in a back end of the production facility.

### DETAILED DESCRIPTION

### Overview

The Detailed Description explains embodiments of the subject matter and the various features and advantageous details more fully with reference to non-limiting embodiments and examples that are described and/or illustrated in the accompanying figures and detailed in the following attached description. Descriptions of well-known components and processing techniques may be omitted so as to not unnecessarily obscure the embodiments of the subject matter. The examples used herein are intended merely to facilitate an understanding of ways in which the subject matter may be practiced and to further enable those of skill in the art to practice the embodiments of the subject matter. Accordingly, the examples, the embodiments, and the figures herein should not be construed as limiting the scope of the subject matter.

This disclosure describes processes and techniques for separating solids from liquids in a process stream obtained from the production facility. The process distributes one or more chemicals to the process stream to help aggregate/flocculate suspended solids and then uses a dewatering device to separate the suspended solids from liquid composed of dissolved solids stream. This will reduce a number of total solids in downstream process streams, reduce viscosity of the liquid streams, and allow for more efficient dewatering or separating of the solids from the liquids. Furthermore, the process may concentrate soluble solids more easily since the suspended solids are separated from the process stream. Thus, the process reduces energy usage downstream and operating costs while improving efficacy in the production facility.

In an embodiment, a separation process adds an effective amount of the chemical to a process stream. The chemical induces flocculation by causing particles to aggregate and to form flocculations (alternatively, flocs) of suspended solids. The process may use an online static mixer or an agitator in a tank to mix the chemical with the process stream to cause the particles to come together or to collide, allowing large-size clusters to form. Next, the process uses the dewatering device to separate the suspended solids from the liquid stream composed of dissolved solids in the process stream. In an embodiment, the process removes the majority of the soluble components from the solids with a washing feature (not shown) in the dewatering device. For instance, the process sends the liquid stream composed of dissolved solids to fermentation and sends the suspended solids, such as lignin and other components, to a dryer.

In another embodiment, the process performs similar steps as described above, adding the chemical and dewatering the process stream with a treatment process. The process sends a mixture (i.e., chemical, process stream, and a liquid filtrate) through the dewatering device to create a first liquids stream and a first suspended solids. The process sends the first liquids stream (i.e., liquid with dissolved solids stream) to the treatment process to remove any additional residuals and the first suspended solids from the dewatering device to drying. Next, the treatment process creates a liquid filtrate, a second liquids stream, and a second suspended solids. The process further sends the liquid filtrate from the treatment process to be added to chemical and process stream in the tank, sends the second liquids stream from the treatment process to fermentation, and sends the second suspended solids from the treatment process to the process stream and/or dryer.

In yet another embodiment, the process performs similar steps as described above, adding the chemical, dewatering the stream, but adds a mechanical device. The process sends a mixture through a mechanical device to create a first liquids stream (i.e., liquid with dissolved solids stream) and a first suspended solids. The process sends the first liquids stream from the mechanical device to the treatment process and the first suspended solids from the mechanical device to the dewatering device. The dewatering device creates a second liquids stream and a second suspended solids. The process sends the second liquids stream from the dewatering device to the treatment process and the second suspended solids from the dewatering device to drying.

In another embodiment, the treatment process creates a third liquids stream and a third suspended solids. The process further sends the third liquids stream from the treatment process to fermentation and the third suspended solids from the treatment process back to process stream.

Advantages and benefits of the separation process include creating a liquid for fermentation that may be essentially devoid of suspended solids and removing soluble solids from suspended solids to allow for more robust drying and combustion. This allows for fermentation with recycle of yeast that greatly reduces the potential of cycling up non-catalytic solids within the fermentation process. Additionally, keeping the suspended solids from the process stream out of the fermentation allows for a higher quality feed co-product to be produced from the overall process stream resulting from fermentation. Removal of sugars and inorganics from the suspended solids streams also prevents fouling of the dryer from caramelized sugars and precipitation of inorganic components. Furthermore, removal of sulfur and nitrogen containing soluble species from the suspended solids decreases the need for emissions control costs when combusting the dried suspended solids.

The terms, liquids stream, liquid with dissolved solids stream, and liquid stream composed of dissolved solids, are used interchangeably to indicate the liquid portion with small sized particles that have passed through separation. The liquid portion includes water, monomeric/oligomeric sugars, soluble inorganic components, other soluble solids, fine particles, and other components. The dissolved solids are used to indicate solids that are dissolved and contain moisture. The terms, suspended solids, suspended solids composed of insoluble solids, are used interchangeably to indicate the solid portion that has been separated out through the separation process.

While aspects of described techniques can be implemented in any number of different processes, environments, and/or configurations, implementations are described in the context of the following example processes.

### Illustrative Process

The processes may be performed using a combination of different environments and/or types of equipment. The equipment should not be construed as necessarily order dependent in their performance. Any number of the described environments, processes, or types of equipment may be combined in any order to implement the method, or an alternate method. Moreover, it is also possible for one or more of the provided steps or pieces of equipment to be omitted.

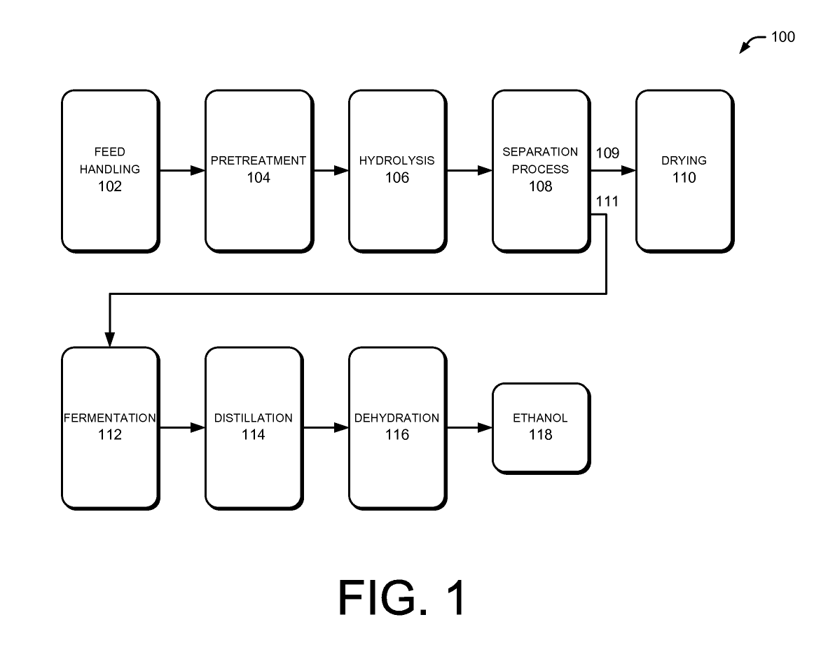

FIG. 1 illustrates an example of a process 100 implementing a series of operations in a production facility. The production facility may include, but is not limited to, biofuels, cellulosic ethanol, alcohol, animal feed, pulp and paper, oil, biodiesel, textile, chemical industry, and other fields. The production facility may be located adjacent to an existing plant to integrate energy, waste, nutrients between a starch-to-ethanol and a cellulosic ethanol plant or the production facility may be a stand-alone plant. The process may use a biochemical or a thermochemical conversion process. It is noted that the separation process may be used in the biochemical or the thermochemical conversion process. The process 100 in the production facility may operate in a continuous manner, in a batch process, or a combination of batch and continuous processes.

As an example, the thermochemical conversion process to produce cellulosic ethanol will be discussed with reference to FIG. 1. The process 100 may harvest, store, and transport feedstock that includes, but is not limited to, lignocellulosic biomass. Lignocellulosic biomass may be grouped into four main categories that include, but are not limited to: (1) wood residues (including wood chips, sawmill and paper mill discards), (2) municipal waste products (including solid waste, wood waste) (3) agricultural wastes (including corn fiber, corn stover, corn cobs, cereal straws, and sugarcane bagasse), and (4) dedicated energy crops (which are mostly composed of fast growing tall, woody grasses, including switch grass, energy/forage sorghum, and Miscanthus). The feedstock may include, an individual type, a combined feedstock of two types, of multiple types, or any combination or blend of the above lignocellulosic biomass. The feedstock may include, but is not limited to, one to four different types combined in various percentage ranges. The feedstock may be converted into different products and co-products that may include, but is not limited to, starch-based and fermentation-based products such as biofuel or ethanol, cellulosic ethanol, food grade protein meal for high protein animal feed, mineral salt stream for fertilizer, solids for generating fuel, organic acids, solvents, and the like. The feedstock may be processed for other applications that include, but are not limited to, producing chemicals for use in other applications, such as plastics, and the like.

For brevity purposes, the process 100 of using a single stream of feedstock will be described with reference to FIG. 1. As an example, lignocellulosic biomass may be used as a single feedstock. The lignocellulosic biomass may be broken down into its major components of cellulose, hemi-cellulose, and lignin and further broken down during the conversion to cellulosic ethanol. The process 100 can covert cellulose and hemicellulose to sugars with enzymes and then ferment to a product with an appropriate microorganism. However, the lignin component presents challenges during processing as it has a tough bonding.

One skilled in the art understands that reducing particle size and cleaning of the lignocellulosic biomass (i.e., feedstock) occurs initially. At feed handling 102, the process 100 initially shreds the feedstock then washes the feedstock to remove dirt, soluble components and other particles. The process 100 then creates a slurry of the feedstock with process water. The use of lignocellulosic biomass as the feedstock requires pretreatment 104 to open the components so enzymes may access the cellulose and the hemicellulose. The process 100 sends the feedstock through pretreatment 104 to further increase its surface area, partially hydrolyzes cellulosic and hemicellulosic components, and to disrupt lignocellulose structure for hydrolyzing agents to access cellulose component, and to reduce crystallinity of cellulose to facilitate hydrolysis.

Pretreatment 104 may include, but is not limited to, mechanical, acid catalyzed, alkaline, biological, or combinations of physical and chemical elements. In an example, pretreatment 104 uses a chemical step combined with high temperatures, mixing and pressure to break down the cellulose and the hemicellulose. For instance, this may include feeding these materials to a presteamer, sending the materials to a reactor, and adding steam and chemicals to the materials in the reactor. The chemical in pretreatment 104 may include but is not limited to sulfuric, phosphoric, hydrochloric, or nitric acids. The process may be a single acid pretreatment or a two-stage acid pretreatment.

The process 100 further adjusts the pH of the pretreated feedstock by neutralizing it with a base to allow the enzymes to function properly in hydrolysis 106. The base that may be used include, but is not limited to, anhydrous ammonia, sodium hydroxide, potassium hydroxide, calcium hydroxide, lime, or any other bases. The calculations for the amount of base are based on a mass balance to adjust the pH for the enzymatic hydrolysis.

Hydrolysis 106 may include acid hydrolysis or enzyme hydrolysis. Acid hydrolysis may include dilute acid or concentrated acid hydrolysis. A person having ordinary skill in the art would be familiar with various options of hydrolysis such as dilute acid, concentrated acid, separate hydrolysis, separate hydrolysis and fermentation, simultaneous saccharification and fermentation, and the like.

Hydrolysis 106 breaks down the complex chains of sugars that make up the hemicellulose and the cellulose. Hydrolysis 106 converts the pretreated feedstock, most of the cellulose and remaining post-pretreatment hemicellulose to glucose (i.e., soluble six-carbon sugars), mannose, galactose, xylose (i.e., soluble five-carbon sugars) and arabinose with a cellulase enzyme cocktail in a hydrolysis tank(s). The cellulase enzyme cocktail breaks down the chains of sugars of cellulose. Hydrolysis 106 may occur for about 12 to about 120 hours to achieve a target enzymatic conversion of glucan to glucose and xylan to xylose. Hydrolysis 106 lowers the temperature range of the hydrolysate to about 303 K to about 308 K (about 30° C. to about 35° C., about 86° F. to about 95° F.) and the pH is controlled in the range of 4 to 5.5 in hydrolysis tank(s).

After hydrolysis 106, the solids tend to be present in large quantities with various particle sizes. The solids tend to be difficult to remove from solution. The solids may negatively affect fermentation issues and downstream processing. Thus, a more efficient method of separation, referred to as a separation process, is used with a chemical and a device.

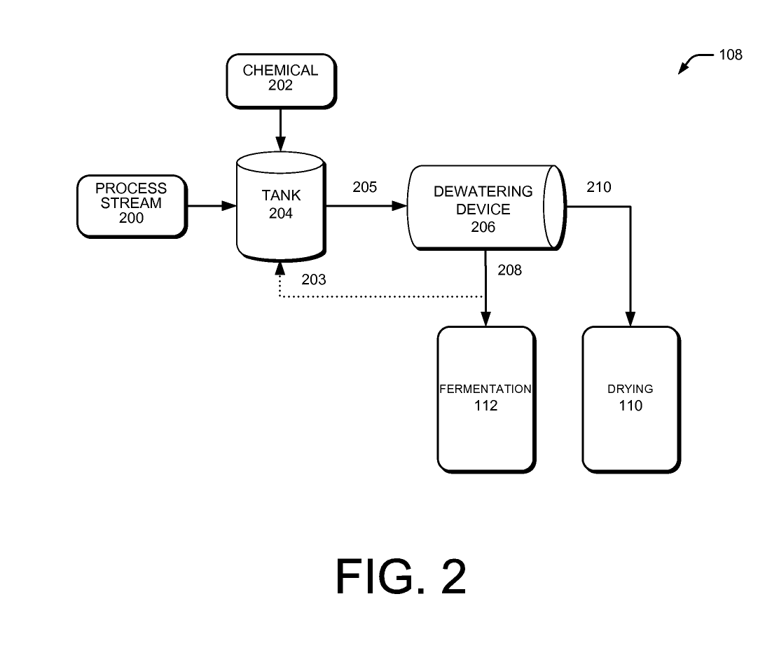

For illustrative purposes in FIG. 1, the separation process 108 is presented at a high level. Details of embodiments of the separation process 108 will be discussed later with reference to FIGS. 2-5. The separation process 108 may be included with any process as part of the cellulosic ethanol production facility or any type of process in a production facility. Specifically, the separation process 108 helps to separate the suspended solids from the liquid with dissolved solids, to provide higher concentration of solids, to decrease capital costs, and to decrease operating costs as well.

The process 100 sends the suspended solids 109 from the separation process 108 to drying 110. The process 100 dries the suspended solids, such as lignin, to remove moisture. The separation process 108 is more effective at separating the suspended solids from the liquid with dissolved solids, so there is less moisture to be removed from the lignin. Since the suspended solids are processed at higher solids than other conventional techniques, this saves on downstream operating costs. The process 100 may monetize the lignin or use the lignin for fuel purposes to produce steam and/or electricity.

The process 100 also sends the liquid with dissolved solids stream 111 from the separation process 108 to fermentation 112 in fermentation tank(s). The liquid with dissolved solids stream 111 includes primarily the sugars and other soluble components. Thus, the process 100 adds one or more microorganisms to the liquid with dissolved solids stream 111 for fermentation 112. The process 100 may use a common strain of microorganism, such as Saccharomyces cerevisiae to convert the simple sugars (i.e., maltose and glucose) into alcohol with solids and liquids, CO₂, and heat. In another example, the process 100 may use another organism, such as Zymomonas mobilis to convert xylose to alcohol in a separate fermentation tank. The process 100 may use a residence time in fermentation 112 as long as about 50 to about 60 hours. However, variables such as a microorganism strain being used, a rate of enzyme addition, a temperature for fermentation, a targeted alcohol concentration, and the like, may affect fermentation time. In embodiments, one or more fermentation tanks may be used in the process 100.

The process 100 creates alcohol, solids, and liquids through fermentation 112. Once completed, the process stream is commonly referred to as beer, which may contain about 4% to about 20% alcohol, plus soluble and insoluble solids from the cellulosic and grain components, microorganism metabolites, and microorganism bodies.

The process 100 distills the beer to separate the alcohol from the non-fermentable components, solids and the liquids by using distillation 114. Distillation 114 may include one or more distillation columns, beer columns, membrane separation devices, liquid/liquid separation devices, and the like. The process 100 pumps the beer through distillation 114, which is boiled to vaporize the alcohol. The process 100 condenses the alcohol vapor in distillation 114 where vapor alcohol exits through a top portion of the distillation 114 at about 88% to about 95% purity, which is about 190 proof, and is subsequently condensed to a liquid. In embodiments, the distillation columns and/or beer columns may be in series or in parallel. Factors affecting distillation 114 include column size, energy flux, product flow rate, materials, and ethanol concentration. The liquid stream exiting the distillation 114 is commonly referred to as stillage, dunder, slop, beer bottoms, and the like.

The stillage is then subjected to evaporating operations. There may be multiple effect evaporators, such as any number of evaporators, from one to about eight or more evaporators. Some process streams may go through a first effect evaporator(s), which operate at higher temperatures, such as ranging to about 373 K (about 99° C. or about 210° F.). While other process streams may go through a second effect evaporator(s), operated at slightly lower temperatures than the first effect evaporator(s), such as ranging from about 328 K to about 360 K (about 130° F. to about 188° F., about 54° C. to about 87° C.). The second effect evaporator(s) may use heated vapor from the first effect evaporator(s) as heat or use recycled steam. In other embodiments, there may be three or four effect evaporator(s), which operate at lower temperatures than the second effect evaporator(s). In embodiments, the multiple effect evaporators may range from one effect up to ten or more effects.

At dehydration 116, the process 100 removes moisture from the 190 proof alcohol by going through a molecular sieve process or equivalent. The dehydration 116 may include one or more drying column(s) packed with molecular sieve media to yield a product of nearly 100% alcohol, which is 200 proof alcohol.

The process 100 adds a denaturant to the alcohol prior to or in a holding tank. Thus, the alcohol is not meant for drinking but to be used for motor fuel purposes. Ethanol 118 is an example product that may be produced, to be used as fuel or fuel additive for motor fuel purposes. The alcohol includes, but is not limited to, ethanol, methanol, propanol, butanol, iso-butanol, drop-in fuels, and the like.

### Illustrative Separation Processes

FIGS. 2-5 illustrate example embodiments of the separation process that may be used with the processes of FIGS. 1 and 6-8. FIG. 2 illustrates the separation process 108 obtaining a process stream 200 of hydrolysate from hydrolysis 106. Other embodiments of the process stream include, but are not limited to, obtaining the process stream from a slurry tank, from a jet cooker, from a first or a second liquefaction tank, after pretreatment in a cellulosic process, any type of process streams in any type of production facilities, and the like.

The chemical 202 may include, but is not limited to, a single polymer, a clarifying agent, a surfactant, a flocculant, a coagulant, a clarifying agent used with a flocculant, a clarifying agent used with a coagulant, two or more clarifying agents, a flocculant, a coagulant, a flocculant used with a clarifying agent, a coagulant used with a clarifying agent, a flocculant used with a coagulant, a coagulant used with a flocculant, two or more flocculants, two or more coagulants, a processing aid, an enzyme, an enzyme combined with any of the above, or a combination of different chemicals to be added to the process stream. Any possible combinations or order of addition of the above is possible.

The chemical 202 may include, but is not limited to, polymers, synthetic water-soluble polymers, dry polymers, emulsion polymers, inverse emulsion polymers, latex polymers, dispersion polymers, and the like. The polymers may include, but are not limited to, long-chained, high-molecular weight, low-to-medium weight, organic chemicals and inorganic chemicals. The polymers may carry a positive charge (i.e., cationic), a negative charge (i.e., anionic), or no charge (i.e., nonionic). Polymers with charges may include, but are not limited to, cationic flocculants, cationic coagulants, anionic coagulants, and anionic flocculants. The cationic (i.e., positive charge) and anionic (i.e., negative charge) polymers may have an ionic charge of about 10 to about 100 mole percent, more preferably about 40 to 80 mole percent.

Clarifying agents cause suspended solids to aggregate, to form a flocculation. Clarifying agents help remove the suspended solids from the liquids. Clarifying agents may include, but are not limited to, alum, aluminum chlorohydrate, aluminum sulphate, sodium silicate, and the like. In some instances, clarifying agents may be referred to, as flocculants.

Flocculants may include starch derivatives, mostly water-soluble, polysaccharides, and alginates. In embodiments, the polymer may be based on a polyacrylamide and its derivatives or an acrylamide and its derivatives. An example may include an acrylamide-acrylic acid resin C₆H₉NO₃ (i.e., hydrolyzed polyacrylamide, prop-2-enamide; prop-2-enoic acid). The polymers have a specific average molecular weight (i.e., chain length) and a given molecular distribution. For suspension, a certain degree of cationic or anionic is beneficial, as flocculating power may increase with the molecular weight. For instance, polyacrylamides have the highest molecular weight among synthetic chemicals, ranging in about 10 to about 20 millions. There are other polymers with specific properties that may be used under specific conditions, which include, but are not limited to, polyethylene-imines, polyamides-amines, polyamines, polyethylene-oxide, and sulfonated compounds. In addition, there are mineral flocculants that are colloidal substances, such as activated silica, colloidal clays, and metallic hydroxides with polymeric structure (i.e., ferric hydroxide, and the like) that may be used. In specific embodiments, the chemicals may be selected for both flocculation and removal of specific soluble components.

Coagulants may include, but are not limited to, alum, ferric sulfate, ferric chloride, ferrous sulfate, and sodium aluminate. Alkalinity measures the ability of a solution to neutralize acids to an equivalence point of carbonate or bicarbonate. Alum, ferric sulfate, ferric chloride, and ferrous sulfate will lower alkalinity and lower pH of solution while sodium aluminate will add alkalinity and raise the pH of the solution.

The chemical may include, but is not limited to surfactants, such as wetting agents, emulsifiers, foaming agents, dispersants, and the like. The surfactant contains a water insoluble (or oil soluble) component and a water-soluble component. The surfactant may diffuse in water and adsorb at interfaces between air and water or at the interface between oil and water, in the case where water is mixed with oil.

A processing aid may include, but is not limited to aluminum ammonium sulfate, potassium sulfate, and the like. The processing aid will reduce the amount of chemical needed to create the flocs and clusters. The amount of processing aid may range from 4000 to 5000 ppm for 100 ppm of chemical being used. However, factors that may affect the dosage are based on type of processing aid, type of chemical, process stream parameters (pH, temperature, etc.), amount of solids, and the like.

The enzyme may include, but is not limited to protease, cellulase enzyme, cocktail of cellulase enzyme, cellulosic enzyme, cocktail of cellulosic enyzmes, and the like.

The chemical 202 may be supplied as dry powder, liquid form, or concentrated solutions by suppliers who are skilled in the art. The preparation of the chemical 202 may require aging times and mixing, which are dependent on the type of products, chemicals, temperature of water, pH of stream, use of chemical within a certain period, combination of chemicals, and the like.

The chemical used is GRAS approved meaning it satisfies the requirements for the United States' Federal and Drug Administration (FDA) category of compounds that are “Generally Recognized As Safe.” The chemical may also be approved by government agencies, such as the U.S. Food and Drug Administration, the Center for Veterinary Medicine, and the Association of American Feed Control Officials based on their standards. Since the chemical is GRAS approved, it does not need to be removed and may be included in distiller products and be fed to livestock and/or other animals when used within the dosage and application guidelines established for the particular product formulation. Also, the chemical may be considered a processing aid under the government agencies, such as the U.S. Food and Drug Administration, the Center for Veterinary Medicine, and the Association of American Feed Control Officials based on their standards.

The separation process 108 adds an effective amount of the chemical 202 to the process stream 200 and adds liquid filtrate 203 in a tank 204 to allow the chemical 202 to be dispersed. Other possible ways of adding the chemical 202 include, but are not limited to, fed into a clarifier, fed into a thickener feed well, use of an online static mixer, and the like. An effective dosage amount of chemical 202 may range from about 10 to about 10,000 parts per million (ppm). Another effective dosage may be used in concentrations of about 0.05% to about 10% chemical 202 according to standard practices and recommended aging times for preparing dry polymers. The chemical 202 may be added at varying concentrations, at different stages of the process, and the like. The dosage amount of chemical 202 depends on factors, such as types of polymers provided, process streams, amount of flocculation desired, types of devices used, and the like. As discussed above, there may be more than one chemical used in the process.

In another embodiment, the separation process 108 does not add any liquid filtrate 203 to the tank 204. Thus, the dotted line 203 shown in FIG. 2 would not be present.

The chemical may be used in varying concentrations, added at different stages, added simultaneously, either as a pre-mix or alternatively separately. There are many factors that affect flocculation. These factors include, but are not limited to, type of chemical, amount of dosage, effect of shear on the flocs, particle size, density of materials, molecular weight, pH of materials, and temperature.

A chemical chosen may help destabilize the charges of the particles. For instance, the chemical chosen may have charges opposite those of the suspended solids to neutralize the charges on the dissolved solids. Or in some instances, London-Van der Waals forces may overpower repulsion forces when the solid particles are close together.

Next, the chemical 202 induces flocculation by causing suspended solids in the process stream 200 to form random, three-dimensional structures that are loose and porous, referred to as flocs. The chemical 202 causes the suspended solids to come together or to collide, allowing large-size clusters to form. This improves the dewatering process by bringing the suspended solids together and creating large-size clusters.

The separation process 108 may use an inline static mixer or an agitator in the tank 204 to create sufficient agitation for complete and even distribution of the chemical 202. In an embodiment, the agitator may include a paddle prop that is flat to obtain desired mixing. However, excessive agitation is to be avoided, or excess shear may break down the flocs, since the bonding forces are relatively weak. Other types of mixing may include a low speed impeller on an agitator shaft, to gently mix the chemical in the process stream. The separation process 108 agitates the chemical 202 with the process stream 200 and the liquid filtrate 203 received from a dewatering device 206 to create a mixture 205 in the tank 204. The mixing or agitation time may range from about 10 seconds to about 10 minutes. The time is dependent on the type of process stream, quantity of process stream, amount of chemical, amount of liquid filtrate, type of chemical, speed of mixer, speed of agitator, type of agitator, and the like.

The mixture 205 (i.e., chemical, process stream, liquid filtrate) may have about 2 to about 20 w/w % suspended solids. Next, the dewatering device 206 separates the components in the mixture 205, such as separating the liquid with dissolved solids stream 208, which includes sugars, acids, inorganic and other components from the suspended solids 210, which include lignin and other components. A portion of the liquid with dissolved solids stream, referred to as the liquid filtrate 203 may be sent to the tank 204. In an embodiment, the separation process 108 sends the liquid with dissolved solids stream 208 to fermentation 112 and sends the suspended solids 210 to drying 110. In embodiments, the suspended solids may be recycled back to the process stream.

The dewatering device 206 may perform using mechanical energy or by a static gravity separation, and the like. The dewatering device 206 may include, but is not limited to, rotary presses, rotary thickeners, hydrocyclones, dynamic filtering screens, static screens, dewatering screens, pressure screens, gravity DSM screens, vibration screens, screw presses, belt filter presses, continuous belt filter presses, vacuum filters, centrifuges, paddle screens, dewatering screws, gravity separators, tanks, sedimentation basins, depth filters, columns, mixer-settlers, skimmers, and the like. The type of dewatering device 206 to be used depends on factors, such as the percent of solids, type of process streams, type of chemical, liquid content at start and at end of process, and the like. There may be one or more of these devices used in the separation process 108.

In an embodiment, the separation process 108 uses a rotary press as the dewatering device to separate components in the mixture 205, such as separating the suspended solids 210 from the liquid with dissolved solids stream 208. An example rotary press includes a dewatering unit with a 3-inch channel, screen, gear unit, feed inlet, motor, filtrate discharge, and solids discharge. The rotary press receives the mixture 205 between two parallel filtering elements in the channel. The rotary press rotates the mixture 205 between the two parallel filtering elements to pass filtrate, such as the liquid with dissolved solids stream 208, while the suspended solids 210 advances with the channel. The rotary press dewaters the mixture 205 as it travels around the channel. The rotary press generates back pressure to dewater the suspended solids 210 and extrude suspended solids 210. It may also include a chemical tank with mechanical mixer to mix the chemical 202 and an inline magnetic flow meter to measure flow rate to dispense the chemical 202. Any type or size of rotary press may be implemented in this process, the one described above is an example of one.

The rotary press may include an option to spray wash the suspended solids 210 to remove the additional amounts of soluble components. The separation process 108 may include a spray feature to direct a liquid medium at the suspended solids. The process may adjust the liquid medium, such as wash water or solvent, based on the type of insoluble solids, type of mixture, temperature, pH, and other factors. The results with the rotary press are discussed under the Examples of Test Results Section.

In yet another embodiment, the separation process 108 uses a rotary drum thickener (RDT) that includes a screen of wedge-wire or woven mesh on a drum. The screen separates the liquid with dissolved solids (i.e., cellulose and hemicellulose polymers, protein, gluten, soluble sugars, salt, and the like) from the suspended solids (i.e., lignin). The screen has openings sized to allow water, dissolved components, and smaller sized particles to flow through the screen but will not allow the larger sized particles (including the flocs)to flow through. Modifying the screen size effects the efficiency of the separation and the filtering area required for the separation.

An example of a drum may be about 36 inches in diameter and about 72 inches long with 0.020 inch openings for a pilot plant evaluation. The RDT includes internal and external spray system, flow distribution spray, variable drum drive system, drive belt, and the like. It may also include a chemical tank with mechanical mixer to mix the chemical 202 and inline magnetic flow meter to measure flow rate to dispense the chemical 202.

The RDT receives the mixture of the process stream 200, the chemical 202, and the filtrate 203 from the tank 204. The RDT sends the mixture 205 onto a distribution tray where it is directed onto a portion of the rotating drum. A liquid with dissolved solids stream 208 passes through openings in the rotating drum while a suspended solids stream 210 remain on a drum surface for further dewatering. The RDT collects the liquid with dissolved solids stream 208 from the underside of the drum screen to a discharge chute into a tank or other suitable receiving device. The liquid with dissolved solids stream 208 may be referred to as a clarified sugar stream, which contains fermentable carbon source, sugars, to be sent to the fermentation 112 for fermenting to produce ethanol or other product (butanol, iso-butanol, microbial produced oils, drop in fuels, and the like).

The RDT may include flights located inside of the rotating drum to slowly transport the suspended solids 210 towards a discharge end of the rotating drum. The suspended solids 210 may fall into a discharge chute into a tank or other suitable receiving device. The product may be referred to as suspended solids 210 to be further processed. The RDT also includes a washing feature to feature to remove a majority of the soluble components from the solids. Factors such as drum speed, mixer speed, and spray water cycling may be adjusted for maximum performance in the RDT. Any type or size of RDT may be implemented in this process, the one described above is an example of one.

The chemical processes may include adjusting the pH of the process stream before adding the chemical. This ensures that the chemical will induce flocculation in the process stream. The type of materials to be added is bases and acids to adjust the pH, commonly understood by a person having ordinary skill in the art. An embodiment includes the process adding 50% caustic to the process stream before adding the chemical.

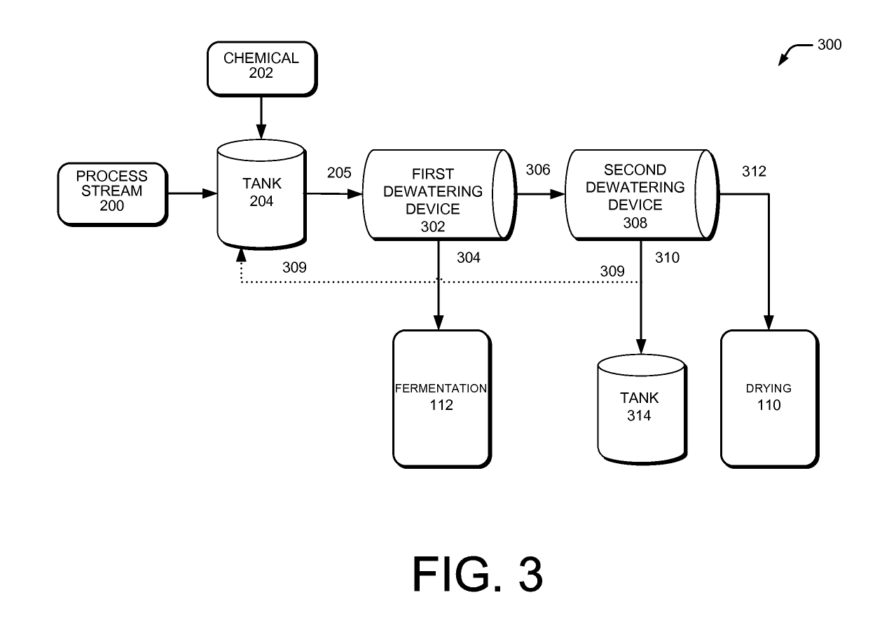

FIG. 3 is similar to FIG. 2, except this figure illustrates another embodiment of the separation process 300 with two dewatering devices. Details that are not similar to FIG. 2 will be discussed below with reference to FIG. 3.

The separation process 300 includes a first dewatering device 302 that separates a first liquid with dissolved solids stream 304 from a first suspended solids 306. The separation process 300 sends the first liquid with dissolved solids stream 304 to fermentation 112. The separation process 300 sends the first suspended solids 306 to a second dewatering device 308 that further separates the components to a liquid filtrate 309, a second liquid with dissolved solids stream 310, and a second suspended solids 312. The separation process 300 optionally sends a portion of the second liquid with dissolved solids stream 310, the liquid filtrate 309 to the tank 204 to be used in the mixture 205, sends the second liquid with dissolved solids stream 310 to a tank 314 or to be used in other parts of the process, and sends the second suspended solids 312 to drying 110. In embodiments, the suspended solids may be recycled back to the process stream.

In embodiments, the first and the second dewatering devices may be any type of combinations including, but not limited to, similar types of devices, different types of dewatering devices, one device operates by mechanical energy and the other operates by static gravity separation, and the like. In embodiments, the first and the second dewatering devices may each have a washing feature to remove majority of the soluble components from the solids, or the first or the second dewatering device only may include the washing feature (not shown). The washing feature may include a spray wash option to direct a liquid medium at the components or include a wash water or solvent to wash the components. The liquid medium may include, but is not limited to, cook water, clean water, recycle water, wash water, alcohol, methanol, butanol, ethanol, and the like. The washing feature may occur initially, may occur in first or a second stage or occur in multiple stages.

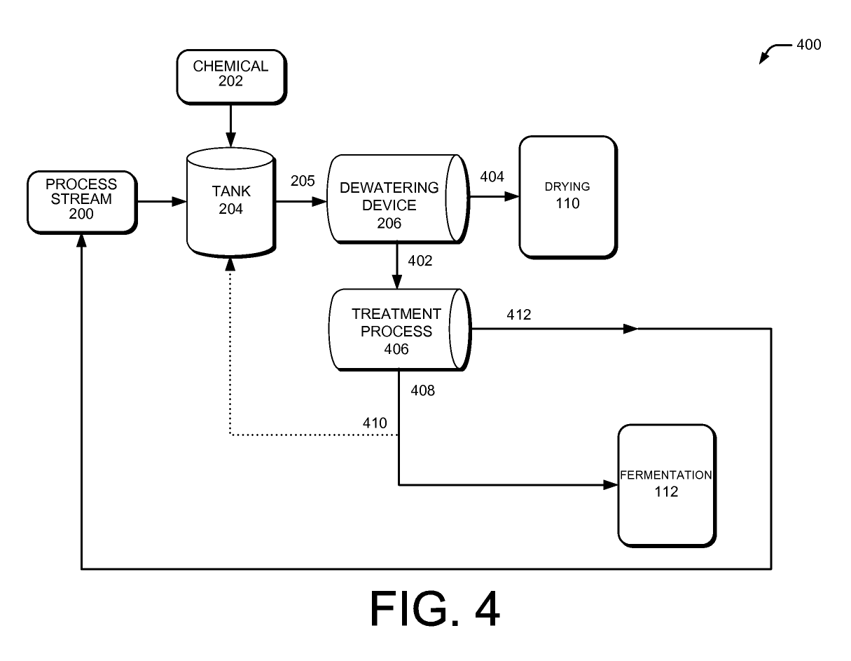

FIG. 4 is similar to FIG. 2, except this figure illustrates another embodiment of the separation process 400 with a treatment process. Details that are not similar to FIG. 2, will be discussed below with reference to FIG. 4.

The separation process 400 sends the mixture 205 (i.e., chemical, process stream, and a liquid filtrate) through the dewatering device 206. The dewatering device 206 separates a first liquid with dissolved solids stream 402 from a first suspended solids 404. The separation process 400 sends the first liquid with dissolved solids stream 402 to the treatment process 406 that further removes residual solids and/or further processes the materials and sends the first suspended solids 404 to drying 110. The dewatering device 206 may include a washing feature as described above.

The treatment process 406 creates a second liquid with dissolved solids stream 408, the liquid filtrate 410, and a second suspended solids 4412. The separation process 400 further sends the liquid filtrate 410 from the treatment process 406 to be added to mixture 205 in the tank 204, sends the second liquid with dissolved solids stream 408 from the treatment process 406 to fermentation 112, and sends the second suspended solids 412 from the treatment process 406 to process stream 200. In other embodiments, the process may send a portion or all of the suspended solids another process stream.

The treatment process 406 includes, but is not limited to, using at least one of a low shearing device, a polishing device, adding retention time, adjusting pH, and/or increasing temperature. The treatment process may use a single process or a combination of the processes may be used. For clarification, the polishing device is used to remove suspended solids, and is not being used to polish material.

In an embodiment, the shearing device shears the large-size particles in the suspended solids to break apart the flocs. The advantages for shearing are to reduce the particle size and to break the bond between the components and the like. The shearing device provides a small amount of shear to break the flocs and to break the bonds formed. The shearing device may include, but is not limited to, a centrifugal pump, a venturi pump, an aspirator pump, an agitator in a settling tank, a static mixer, a disc mill, and the like to allow for a more robust drying process.

In yet another embodiment, the polishing device may include but is not limited to, polishing centrifuge, decanting centrifuge, decanter, centrifugal dryer, spin dryer, cyclone centrifugal screening machine, a three phase decanter, three phase disc centrifuge, and the like.

In another embodiment, the separation process uses retention time to allow the suspended solids with chemical to age for a period of time, ranging anywhere from about 0.5 hour up to about 12 hours in a settling tank. Factors that affect the retention time include, but are not limited to, type of chemical, type of process streams, solids content, and the like.

In yet another embodiment, the separation process may supply heat to the suspended solids for a predetermined amount of time in a settling tank. The predetermined amount of time ranges from about 15 seconds to about 15 minutes. The separation process may raise the temperature in the settling tank. This may raise the temperature of the suspended solids to at about 110° F. (43° C. or 317 K) and up to about 212° F. (100° C. or 373 K). In an embodiment, the separation process adds a hydroheater to raise the temperature and to break remaining flocs of the suspended solids.

In still yet another embodiment, the separation process may also include adjusting the pH of the suspended solids. For instance, the process adjusts the pH by adding sodium to increase the pH. Examples include caustic (NaOH), alkaline, alkali, base.

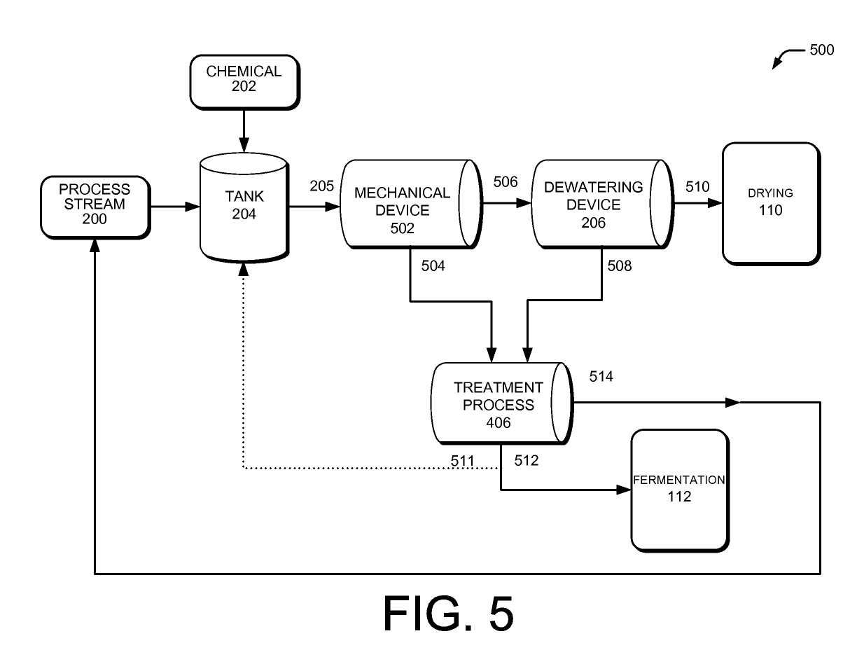

FIG. 5 is similar to FIG. 4, except this figure illustrates another embodiment of the separation process, but with a mechanical device. Details that are not similar to FIG. 4 will be discussed below with reference to FIG. 5.

The separation process 500 includes a mechanical device 502 that separates the components of the mixture 205, into a first liquid with dissolved solids stream 504 and a first suspended solids 506. The process 500 sends the first suspended solids 506 to the dewatering device 206 that creates a second liquid with dissolved solids stream 508 and a second suspended solids 510. The separation process 500 sends the first and second liquid with dissolved solids streams 504, 508 to a treatment process 406 that further removes residual solids. Next, the treatment process 406 creates liquid filtrate 511, a third liquid with dissolved stream 512, and a third suspended solids 514. The separation process 500 further sends liquid filtrate 511 to the tank 204, sends the third liquid with dissolved stream 512 from the treatment process 406 to fermentation 112, and sends the third suspended solids 514 from the treatment process 406 back to process stream 200.

In embodiments, the mechanical device 502 may include but is not limited to, rotary drum thickener, paddle screen, multi-zoned screening apparatus, centrifuge, decanter, filter press, dewatering screw, gravity separator, static gravity separation, mixer-settler, skimmer, or any other type of separation device. The mechanical device may include a washing feature in embodiments.

In yet another embodiment, the treatment process may be a polishing device including but is not limited to, polishing centrifuge, decanting centrifuge, decanter, centrifugal dryer, spin dryer, cyclone centrifugal screening machine, a three phase decanter, three phase disc centrifuge, and the like. The polishing device may include a washing feature in embodiments.

In another embodiment, the treatment process may operate by using static gravity separation, which is efficient at separating one component, the suspended solids from the other components by gravity. This is possible due to all of the components of the mixture (i.e., process stream) having different specific weights. The gravity separation methods use gravity as a dominant force to separate out the components. For instance, the gravity separation separates the components based on the characteristic of the process stream, such as suspension. Advantages of using gravity separation include low capital and operating costs.

### Other Illustrative Environments

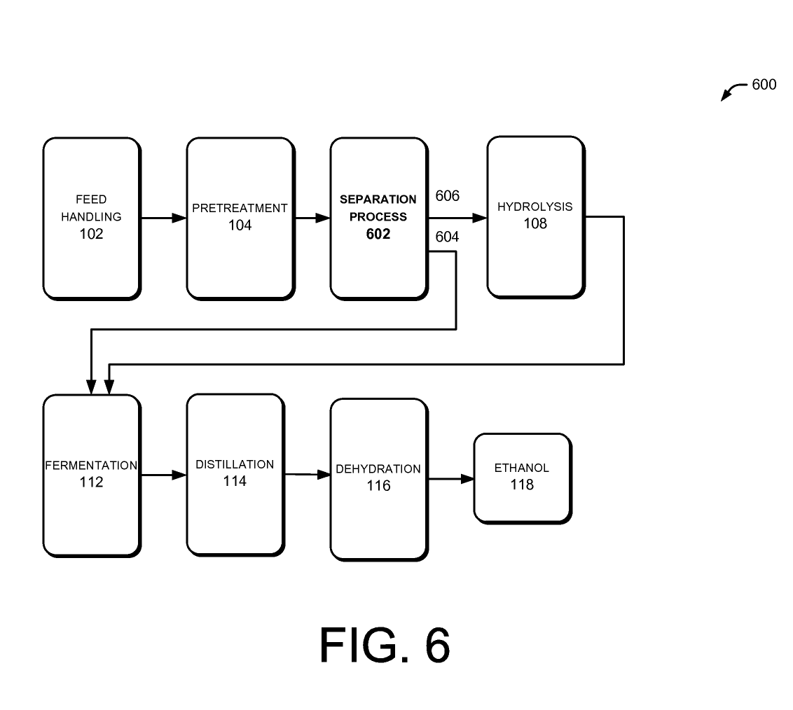

FIGS. 6-8 are flow diagrams showing example processes that may include the separation process. FIG. 6 is similar to FIG. 1, except this figure illustrates the example process 600 having the separation process 602 located before hydrolysis 108. The separation process 602 is located in the front end of the production facility. The separation process 602 receives the process stream from pretreatment 104 and goes through one of the separation processes discussed with reference to FIGS. 2-5. The separation process 602 sends liquid with dissolved solids 604 to fermentation 112 and sends the suspended solids 606 to hydrolysis 108.

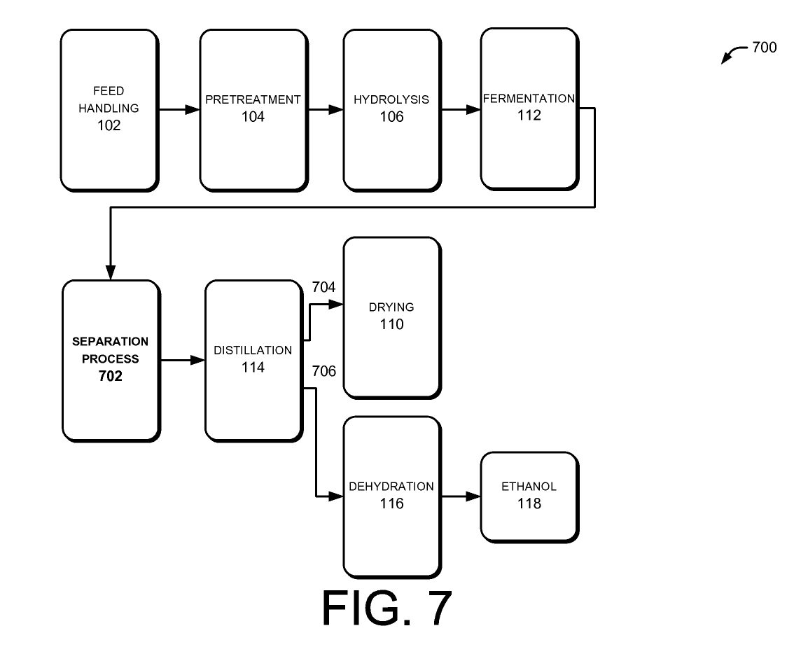

FIG. 7 is similar to FIG. 1, except this figure illustrates an example process 700 having the separation process 702 located after fermentation 112. The separation process 702 is located in the front end of the production facility. The separation process 702 receives the process stream from fermentation 112 and goes through one of the separation processes discussed with reference to FIGS. 2-5. The separation process 702 sends the process stream to distillation 114. From distillation 114, the process 700 sends liquid with dissolved solids 704 to drying 110 and sends the suspended solids 706 to dehydration 116, which becomes ethanol 118.

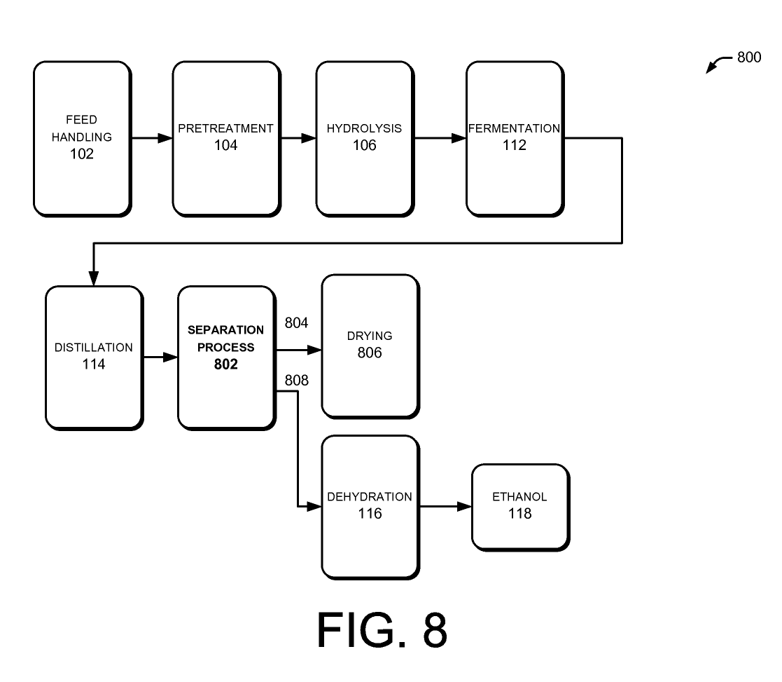

FIG. 8 is similar to FIG. 1, except this figure illustrates another example process 800 having the separation process 802 located after distillation 114. The separation process 802 is located in the back end of the production facility. The separation process 802 receives the process stream from distillation 114 and goes through one of the separation processes discussed with reference to FIGS. 2-5. The separation process 802 sends liquid with dissolved solids 804 to drying 806 and sends the suspended solids 808 to dehydration 116, which becomes ethanol 118.

### Examples of Test Results

The separation process was replicated in a pilot plant based on using energy sorghum hydrolysate as the process stream, adjusting the pH on hydrolysate, adding a coagulant (i.e., alum) with an acrylamide based polyelectrolyte polymer, and using a rotary press. Table I. below indicates the different variables in the pilot plant runs.

TABLE I
Chemical Process Back-End

| | Polymer | | | |
|---|---|---|---|---|
| | Dosage | Filtrate | Solids | |
| Runs | (concentrate) | (% TSS) | (% cake) | Capture Rate |
| 1a | 25% | 0.04% | 49.23% | 99.5% |
| 1b | 25% | 0.23% | 48.37% | 97.2% |
| 1c | 25% | 0.17% | 56.14% | 98.0% |
| 1d | 25% | 0.14% | 53.96% | 98.4% |
| 1e | 25% | 0.22% | 57.71% | 97.4% |
| Avg. | 25% | 0.16% | 53.08% | 98.1% |

Table I shows in a first vertical column the different runs, 1a-1e, Avg., and shows in a first row, Polymer Dosage, Filtrate, Solids, and Capture Rate. The data illustrates the % solids ranging from 49.23% to 57.71%. Previous percent solids with conventional devices and methods ranged from 35% to 45% solids. This illustrates a more efficient dewatering mechanism. The data illustrates excellent capture rates ranging from 97.2% to 99.5% based on the filtrate percent.

Additional laboratory studies were conducted using hydrolysate along with two coagulants. A first coagulant not identified by Vendor A was added at about 400 ppm (v/v) to hydrolysate to cause neutralization followed by a second coagulant not identified by Vendor A at about 120 ppm (v/v), which produced a very dry material.

Another separation process was replicated in a pilot plant based on using switchgrass hydrolysate as the process stream, adjusting the pH on the process stream, adding a polyacrylamide or its derivatives to the switchgrass hydrolysate (i.e., process stream), and using a filter press to separate out suspended solids from the process stream with the polyacrylamide or its derivatives. Table II below shows the mean values for the these materials and a control in the pilot plant run.

TABLE II
Chemical Process

| Run ID | Mean | Std | Lower | Upper |
|---|---|---|---|---|
| No. | (flux gpm/ft²) | Dev | 95% | 95% |
| 4 | 0.025951 | 0.002885 | 0.02136 | 0.03054 |
| 16 | 0.014375 | 0.003314 | 0.01261 | 0.01614 |

Table II shows in a first vertical column the data with Run ID No. 4, which is the polyacrylamide or its derivatives with the process stream through a filter press, and Run ID No. 16 as the control, which includes no chemical added but the process stream is run through a filter press. The data shows Run ID No. 4 at 0.025951 flux gpm/ft² is significantly different than Run ID No. 16 at 0.014375 flux gpm/ft² based on the use of the chemical. The chemical significantly improves flocculations of suspended solids and ultimately the separation of suspended solids.

There are additional laboratory evaluations and pilot plant studies performed using different types of chemicals, different polymer dosages, different devices, and the like.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method comprising:
adding an effective amount of a chemical to a process stream to induce flocculations of suspended solids;
separating the suspended solids from the process stream by using a device;
creating (1) a first liquid with dissolved solids stream and (2) a first suspended solids stream;
treating the first liquid with dissolved solids stream to remove residuals by using a treatment process; and
creating (3) a second liquid with dissolved solids stream and (4) a second suspended solids stream.

2. The method of claim 1, wherein the chemical comprises a coagulant.

3. The method of claim 1, wherein the process stream comprises hydrolysate obtained from a cellulosic production.

4. The method of claim 1, wherein the device for separating the first suspended solids comprises at least one of a rotary drum thickener, a paddle screen, a multi-zoned screening apparatus, a centrifuge, a decanter, a filter press, a dewatering screw, a gravity separator, a static gravity separation, or a mixer-settler.

5. The method of claim 1, wherein the treatment process comprises at least one of applying a shearing device to the first liquid with dissolved solids stream, applying a polishing device to the first liquid with dissolved solids stream, using a retention time for the first liquid with dissolved solids stream in tank, adjusting pH of the first liquid with dissolved solids stream in a tank, or increasing temperature of the first liquid with dissolved solids stream in a tank.

6. The method of claim 1, further comprising sending the second liquid with dissolved solids stream to fermentation.

7. A method comprising:
adding an effective amount of a chemical to a process stream combined with a liquid filtrate to cause two or more particles to aggregate to form flocculations of suspended solids;
separating the suspended solids from a combination of the chemical, the process stream, and the liquid filtrate by using a dewatering device; and
creating (1) a liquid with dissolved solids stream and (2) a suspended solids stream.

8. The method of claim 7, wherein the chemical comprises a polyacrylamide and its derivatives or an acrylamide and its derivatives.

9. The method of claim 7, wherein the chemical meets approval as Generally Recognized As Safe or approval by government agencies.

10. The method of claim 7, wherein the process stream comprises hydrolysate obtained from a cellulosic production.

11. The method of claim 7, wherein the liquid filtrate comprises a partial stream diverted from the liquid with dissolved solids stream.

12. The method of claim 7, wherein the dewatering device comprises at least one of a filter press, a rotary press, a rotary thickener, a dynamic filtering screen, a dewatering screen, a belt filter press, a continuous belt filter press, or a dewatering screw.

13. The method of claim 7, wherein the dewatering device comprises a washing feature to remove a majority of soluble components from the suspended solids stream.

14. The method of claim 7, furthering compromising sending the liquid with dissolved solids stream to a treatment process, wherein the treatment process comprises at least one of applying a shearing device to the liquid with dissolved solids stream, applying a polishing device to the liquid with dissolved solids stream, using a retention time for the liquid with dissolved solids stream in tank, adjusting pH of the liquid with dissolved solids stream in a tank, or increasing temperature of the liquid with dissolved solids stream in a tank.

15. The method of claim 7, furthering comprising sending the suspended solids stream to a dryer.

16. A method comprising:
adding an effective amount of a polyacrylamide or its derivatives to a process stream to induce flocculations of suspended solids;
mixing the chemical with the process stream for a predetermined amount of time;
separating the flocculations of suspended solids from the process stream by using a device; and
creating a liquid with dissolved solids stream and a suspended solids stream.

17. The method of claim 16, wherein the polyacrylamide or its derivatives comprise a cationic or an anionic charged polymer.

18. The method of claim 16, wherein the predetermined amount of time comprises ranging from about 15 seconds to 15 minutes.

19. The method of claim 16, further comprising adding a processing aid to reduce the amount of polyacrylamide or its derivatives needed for inducing flocculations of suspended solids.

20. The method of claim 19, wherein the processing aid comprises at least one of aluminum ammonium sulfate or potassium sulfate.
